(19) United States
(12) Patent Application Publication
(10) Pub. No.: US 2016/0342679 A1
(43) Pub. Date: Nov. 24, 2016

(54) RECOMMENDATION METHOD AND RECOMMENDATION SYSTEM APPLIED TO SOCIAL NETWORK

(71) Applicants: Kaiyi ZHU, Shanghai (CN); SHANGHAI FUSION MANAGEMENT SOFTWARE CO., LTD., Shanghai (CN)

(72) Inventor: Kaiyi Zhu, Shanghai (CN)

(21) Appl. No.: 15/111,054

(22) PCT Filed: Jan. 9, 2015
(86) PCT No.: PCT/CN2015/070428

§ 371 Date: Jul. 12, 2016

(30) Foreign Application Priority Data
Jan. 16, 2014 (CN) 201410019906.8
Apr. 29, 2014 (CN) 201410177011.7

(51) Int. Cl. G06F 17/30

(52) U.S. Cl. CPC G06F 17/30598; G06F 17/30867; G06F 17/3097

(57) ABSTRACT

A recommendation method and system are provided. The method includes: extracting basic information of a target user in a supplier resource information category as a first supplier keyword, and extracting basic information of the target user in a first demander resource information category as a first demander keyword; performing clustering on users in the social network to form a first cluster; where a user in the first cluster acts as a first recommendable user, basic information of the first recommendable user in the supplier resource information category is used as a second supplier keyword, basic information of the first recommendable user in the first demander resource information category is used as a second demander keyword, the second supplier keyword matches with the first demander keyword, and the second demander keyword matches with the first supplier keyword; recommending the first recommendable user to the target user.

The present disclosure claims the priority to Chinese Patent Application 201410019906.8, titled “METHOD FOR ORGANIZING SOCIAL GROUP ON THE INTERNET”, filed on Jan. 16, 2014 with the State Intellectual Property Office of the People's Republic of China, and Chinese Patent Application 201410177011.7, titled “METHOD AND SYSTEM FOR SOCIALIZING”, filed on Apr. 29, 2014 with the State Intellectual Property Office of the People's Republic of China, the entire content of which are incorporated herein by reference.

### TECHNICAL FIELD

The present disclosure relates to the technical field of information processing in a social network, and in particular to a recommendation method and a recommendation system applied to a social network.

### BACKGROUND

With the popularity and the development of the Internet, social networks have become important ways for people to make acquaintance and communicate with friends. In a social network, users may perform information interaction with each other, so as to communicate with each other. Specifically, in a case that a user wants to perform the information interaction with one of his or her friend users, the user needs to find the friend user and then establish a communication connection with the friend user.

In a method for searching for the friend user in the conventional technology, user identity information of the friend user, such as ID, email address and telephone number, which can indicated a user identify, is known by the user in advance. In a case that the user wants to search for the friend user, the friend user may be found by the user with the user identity information of the friend user. Social tools on the Internet such as ICQ, msn, QQ, WeChat, Laiwang, Yixin and whatApp, provide the above method for searching for the friend user.

It can be understood that, according to the method for searching for the friend user in the conventional technology, the user needs to know the user identity information of the friend user in advance, that is, only a friend in real life of the user can be found by him or her as the friend user on the social network. It can be seen that the method can only transfer an offline friend to an online friend for the user. In a practical application of the social network, the user usually needs to search for and communicate with a friend user, who is not a friend in the real life of the user, but is a user that is not familiar to the user in the real life and has some special characteristics. For example, in a possible application scenario, when the user is about to build an entrepreneurial team, he or she needs to search for and communicate with friend users who are potential members of the entrepreneurial team. On the one hand, the potential members are not friends in the real life of the user, and user identity information of them such as IDs, email addresses and telephone numbers, is not known by the user. On the other hand, the potential members have characteristics which meet the needs of the entrepreneurial team to be built by the user, for example, some of the potential members are in an industry that the entrepreneurial team to be built by the user expects to get into, or, some of the potential members have resources, which are needed by the user when building the entrepreneurial team but not owned by the user. It can be seen that, in the conventional technology, the user needs to utilize the user identity information of the friend user to search for the friend user, and since user identity information of friend users, who are not familiar to the user in the real life but have some special characteristics, is not known by the user, these friend users can not be precisely located in one attempt with the conventional technology. Therefore, the user needs to search for these friend users in the whole social network, which may lead the user to perform second screening on a large number of search results, and may consume a large amount of time and energy of the user in the second screening of the search results.

### SUMMARY

The present disclosure is to provide a recommendation method and a recommendation system applied to a social network, so as to enable a user to precisely locate friend users, who are not familiar to the user but have some special characteristics, in one attempt. Thereby greatly reducing search results on which second screening is to be performed by the user, avoiding that a large amount of time and energy of the user is consumed in the second screening, and bringing a better experience to the user.

In order to solve the above problem, a recommendation method applied to a social network is provided according to the present disclosure, which includes:

in response to a triggering request for recommending a friend user to a target user, extracting basic information of the target user in a supplier resource information category as a first supplier keyword, and extracting basic information of the target user in a first demander resource information category, as a first demander keyword;

performing clustering on users in the social network to form a first cluster, based on the first supplier keyword and the first demander keyword; where a user in the first cluster acts as a first recommendable user, basic information of the first recommendable user in the supplier resource information category is used as a second supplier keyword, basic information of the first recommendable user in the first demander resource information category is used as a second demander keyword, the second supplier keyword is matched with the first demander keyword, and the second demander keyword is matched with the first supplier keyword; and

recommending the first recommendable user to the target user as the friend user.

Optionally, the method further includes:

in response to the first supplier keyword which is the same as the first demander keyword, performing clustering on the users in the social network to form a second cluster, based on the first supplier keyword; where a user in the second cluster acts as a second recommendable user, basic information of the second recommendable user in the supplier resource information category is used as a third supplier keyword, and the third supplier keyword is matched with the first supplier keyword; and

recommending the second recommendable user to the target user as the friend user.

Optionally, the method further includes:

in response to the triggering request for recommending the friend user to the target user, extracting basic information of the target user in a second demander resource information category as a third demander keyword;

performing clustering on the users in the social network to form a third cluster, based on the first supplier keyword, the first demander keyword and the third demander keyword; where the third cluster includes a third recommendable user and a fourth recommendable user; basic information of the third recommendable user in the supplier resource information category is used as a fourth supplier keyword, basic information of the third recommendable user in the first demander resource information category is used as a fourth demander keyword, basic information of the third recommendable user in the second demander resource information category is used as a fifth demander keyword, basic information of the fourth recommendable user in the supplier resource information category is used as a fifth supplier keyword, basic information of the fourth recommendable user in the first demander resource information category is used as a sixth demander keyword, basic information of the fourth recommendable user in the second demander resource information category is used as a seventh demander keyword, the first demander keyword and the fourth demander keyword are matched with the fifth supplier keyword, the third demander keyword and the sixth demander keyword are matched with the fourth supplier keyword, and the fifth demander keyword and the seventh demander keyword are matched with the first supplier keyword; and

recommending the third recommendable user and the fourth recommendable user to the target user as the friend users.

Optionally, the method further includes:

in response to an operation of inputting a target social role performed by the target user, determining the supplier resource information category and the first demander resource information category, from multiple optional information categories, based on the target social role; where correspondence is established among the target social role and the supplier resource information category, and the first demander resource information category, in advance.

Optionally, the pieces of basic information of the target user in information categories which can be used for clustering, are not visible to other users, and the information categories which can be used for clustering include the supplier resource information category and the first demander resource information category.

Optionally, the pieces of basic information of the target user in information categories which can be used for clustering, are included in registration information of the target user.

Optionally, in a case that the first supplier keyword and the second demander keyword each include a numerical value, it is indicated that an error between the numerical value of the first supplier keyword and the numerical value of the second demander supplier is in a preset reasonable error range if the first supplier keyword is matched with the second demander keyword.

Optionally, in a case that the first supplier keyword and the second demander keyword each include a numerical range, it is indicated that a coincidence degree between the numerical range of the first supplier keyword and the numerical range of the second demander keyword is greater than or equal to a preset coincidence degree threshold if the first supplier keyword is matched with the second demander keyword.

Optionally, the method further includes:

in response to a request triggered by the target user for editing an object file in synchronization with the friend user, establishing a communication connection for synchronously editing the object file between the target user and the friend user; and

in response to an editing operation of the target user and/or the friend user on the object file, presenting the object file on which the editing operation is performed, to the target user and the friend user simultaneously, via the communication connection.

Optionally, the method further includes:

searching for information matched with the first supplier keyword and/or the first demander keyword as a search result, with a search engine or a search database, based on the first supplier keyword and the first demander keyword, and recommending the search result to the target user.

Optionally, the method further includes:

in response to the triggering request for recommending the friend user to the target user, extracting basic information of the target user in a property resource information category, as a first property keyword;

performing clustering on the users in the social network to form a fourth cluster, based on the first property keyword; where a user in the fourth cluster acts as a fourth recommendable user, basic information of the fourth recommendable user in the property resource information category is used as a second property keyword, and the second property keyword is matched with the first property keyword; and

recommending a fifth recommendable user to the target user as a friend user, where a user who is included in both the first cluster and the fourth cluster acts as the fifth recommendable user, and the fifth recommendable user is a first recommendable user and a fourth recommendable user.

In addition, a recommendation system applied to a social network is provided according to the present disclosure, which includes:

a first extracting module, configured to, in response to a triggering request for recommending a friend user to a target user, extract basic information of the target user in a supplier resource information category as a first supplier keyword, and extract basic information of the target user in a first demander resource information category as a first demander keyword;

a first clustering module, configured to perform clustering on users in the social network to form a first cluster, based on the first supplier keyword and the first demander keyword; where a user in the first cluster acts as a first recommendable user, basic information of the first recommendable user in the supplier resource information category is used as a second supplier keyword, basic information of the first recommendable user in the first demander resource information category is used as a second demander keyword, the second supplier keyword is matched with the first demander keyword, and the second demander keyword is matched with the first supplier keyword; and

a first recommending module, configured to recommend the first recommendable user to the target user as the friend user.

Optionally, the system further includes:

a second clustering module, configured to, in response to the first supplier keyword which is the same as the first demander keyword, perform clustering on the users in the social network to form a second cluster, based on the first supplier keyword; where a user in the second cluster acts as a second recommendable user, basic information of the second recommendable user in the supplier resource information category as a third supplier keyword, and the third supplier keyword is matched with the first supplier keyword; and

a second recommending module, configured to recommend the second recommendable user to the target user as the friend user.

Optionally, the system further includes:

a second extracting module, configured to, in response to the triggering request for recommending the friend user to the target user, extract basic information of the target user in a second demander resource information category as a third demander keyword;

a third clustering module, configured to perform clustering on the users in the social network to form a third cluster, based on the first supplier keyword, the first demander keyword and the third demander keyword; where the third cluster includes a third recommendable user and a fourth recommendable user; basic information of the third recommendable user in the supplier resource information category is used as a fourth supplier keyword, basic information of the third recommendable user in the first demander resource information category is used as a fourth demander keyword, basic information of the third recommendable user in the second demander resource information category is used as a fifth demander keyword, basic information of the fourth recommendable user in the supplier resource information category is used as a fifth supplier keyword, basic information of the fourth recommendable user in the first demander resource information category is used as a sixth demander keyword, basic information of the fourth recommendable user in the second demander resource information category is used as a seventh demander keyword, the first demander keyword and the fourth demander keyword are matched with the fifth supplier keyword, the third demander keyword and the sixth demander keyword are matched with the fourth supplier keyword, and the fifth demander keyword and the seventh demander keyword are matched with the first supplier keyword; and

a third recommending module, configured to recommend the third recommendable user and the fourth recommendable user to the target user as the friend users.

Optionally, the system further includes:

a determining module, configured to: in response to an operation of inputting a target social role performed by the target user, determine the supplier resource information category and the first demander resource information category from multiple optional information categories, based on the target social role; where correspondence is established between the target social role, the supplier resource information category and the first demander resource information category, in advance.

Optionally, the pieces of basic information of the target user in information categories which can be used for clustering, are not visible to other users, and the information categories which can be used for clustering include the supplier resource information category and the first demander resource information category.

Optionally, the pieces of basic information of the target user in information categories which can be used for clustering, are included in registration information of the target user.

Optionally, in a case that the first supplier keyword and the second demander keyword each include a numerical value, it is indicated that an error between the numerical value of the first supplier keyword and the numerical value of the second demander keyword is in a preset reasonable error range if the first supplier keyword is matched with the second demander keyword.

Optionally, in a case that the first supplier keyword and the second demander keyword each include a numerical range, it is indicated that a coincidence degree between the numerical range of the first supplier keyword and the numerical range of the second demander keyword is greater than or equal to a preset coincidence degree threshold if the first supplier keyword is matched with the second demander keyword.

Optionally, the system further includes:

an establishing module, configured to, in response to a request triggered by the target user for editing an object file in synchronization with the friend user, establish a communication connection for synchronously editing the object file between the target user and the friend user; and

a presenting module, configured to, in response to an editing operation of the target user and/or the friend user on the object file, present the object file on which the editing operation is performed to the target user and the friend user simultaneously via the communication connection.

Optionally, the system further includes:

a fourth recommending module, configured to search for information matched with the first supplier keyword and/or the first demander keyword as a search result, with a search engine or a search database, based on the first supplier keyword and the first demander keyword, and recommend the search result to the target user.

Optionally, the system further includes:

a third extracting module, configured to, in response to the triggering request for recommending the friend user to the target user, extract basic information of the target user in a property resource information category as a first property keyword;

a fourth clustering module, configured to perform clustering on the users in the social network to form a fourth cluster, based on the first property keyword; where a user in the fourth cluster acts as a fourth recommendable user, basic information of the fourth recommendable user in the property resource information category is used as a second property keyword, and the second property keyword is matched with the first property keyword; and

a fifth recommending module, configured to recommend a fifth recommendable user to the target user as the friend user, where a user who is included in both the first cluster and the fourth cluster acts as the fifth recommendable user, and the fifth recommendable user is a first recommendable user and a fourth recommendable user.

Compared with the conventional technology, the present disclosure has the following advantages.

With the method and device according to embodiments of the present disclosure, clustering may be performed on users in a social network, based on supplier keywords inputted in a supplier resource information category by a user and demander keywords inputted in demander resource information categories by the user, and a friend user is recommended to the user based on a clustering result. Specifically, in a case that the friend user is to be recommended to the target user, the supplier keyword and the demander keywords of the target user may be extracted, and clustering is performed on the users in the social network based on the keywords, so as to obtain the recommendable user by performing clustering, who has the supplier keywords matched with the demander keyword of the target user and has the demander keywords matched with the supplier keywords of the target user, thereby recommending the recommendable user to the target user as the friend user. It can be seen that, the friend users who have some special characteristics can be recommended to the user, by performing clustering on the users based on the supplier keyword and the demander keywords of the user, without searching for and locating based on user identity information of the friend users. Therefore, for the friend users, who are not familiar to the user in real life but have some special characteristics, the user can precisely locate them without knowing the user identity information of them, so that the search results on which the second screening is to be performed by the user are greatly reduced, and time and energy of the user consumed in performing the second screening on the search results are saved.

### BRIEF DESCRIPTION OF THE DRAWINGS

In order to more clearly illustrate technical solutions in embodiments of the present disclosure or in the conventional technology, drawings used in the description of the embodiments or the conventional technology are introduced briefly hereinafter. Apparently, the drawings described in the following illustrates some embodiments of the present disclosure, other drawings may be obtained by those ordinarily skilled in the art based on these drawings without any creative efforts.

FIG. 1 is a flow chart of a recommendation method applied to a social network according to an embodiment of the present disclosure;

FIG. 2a is a schematic diagram of a registration information region in an example of a user operation interface according to an embodiment of the present disclosure;

FIG. 2b is a schematic diagram of a clustering information region in an example of a user operation interface according to an embodiment of the present disclosure; and

FIG. 3 is a structural diagram of a recommendation system applied to a social network according to an embodiment of the present disclosure.

### DETAILED DESCRIPTION OF THE EMBODIMENTS

In order to enable those skilled in the art to better understand solutions of the present disclosure, the technical solutions in the embodiments of the present disclosure are clearly and completely described hereinafter in conjunction with the drawings in the embodiments of the present disclosure. Apparently, the described embodiments are only a few of the embodiments of the present disclosure. Based on the embodiments of the present disclosure, all other embodiments obtained by those ordinarily skilled in the art without any creative efforts fall within the protection scope of the present disclosure.

By research, the inventors found that, in the conventional technology, friend users who are not familiar to a user in real life but have some special characteristics can not be precisely located by the user in one attempt, because the user utilizes user identity information of the friend users to search for them. Therefore, in the technical solutions provided according to the embodiments of the present disclosure, clustering is performed on users in a social network based on supplier keywords inputted by the users in a supplier resource information category and demander keywords inputted by the users in a demander resource information category, and the friend users are recommended to the target user, based on a result of clustering the supplier keywords and the demander keywords which are paired, so as to enable the user to precisely locate the friend users who are complementary and are in need for each other in one attempt without performing second screening on a large number of search results. Then, the friend users, who have supplier keywords matched with the demander keyword of the target user and demander keywords matched with the supplier keyword of the target user, can be recommended to the target user by clustering, and the target user does not need to know user identity information of them. Hence, even if the friend users are not familiar to the target user, they can be precisely recommended to the target user by a system in one attempt, thereby greatly reducing the search results on which the second screening is to be performed by the user and saving time and energy consumed in performing the second screening on the search results for the user.

For example, in a possible application scenario of the embodiments of the present disclosure, when the target user is about to build an entrepreneurial team, he or she needs to search for and communicate with friend users who are potential members of the entrepreneurial team. On the one hand, the potential members are not friends in the real life of the target user, and user identity information of them such as IDs, email addresses and telephone numbers, is not known by the target user. On the other hand, the potential members have characteristics which meet the needs of the entrepreneurial team to be built by the target user, for example, some of the potential members are in an industry that the entrepreneurial team to be built by the target user expects to get into, or, some of the potential members have resources, which are needed by the user when building the entrepreneurial team but not owned by the user. In this case, the users may input supplier keywords based on resources owned by them, and input demander keywords based on resources demanded by them, so that the system can recommend the friend users, owned resources and demanded resources of whom are complementary to those of the target user, to the target user, and the friend users are the potential members of the entrepreneurial team to be built by the target user.

It should be noted that the above application scenario is just an example of the embodiments of the present disclosure, and the embodiments of the present disclosure are not limited to the above application scenario and can be applied to any application scenario which is suitable for them. For example, the present disclosure provides a recommendation method and a recommendation system applied to a social network, which can search friend users from a maximum range of netizens and greatly reduce a cost of second screening, by designing a clustering module and analyzing clustering content. The embodiments of the present disclosure can also be applied to application scenarios such as traveling together, hiking together, fishing together, exercising together, playing cards together and playing chess together. In addition, the embodiments of the present disclosure may be implemented in any network architecture. Structures of the current Internet include a C/S structure, Client/Server, and a B/S structure, Browser/Server, and these two mainstream structures of the Internet may achieve the same technical effect. Connection and transmission modes between a personal terminal and a website are usually determined by wired and wireless communication protocols, which include using a wired network and using a wireless network. The mode in which the wireless network is used may be 2G, 3G and 4G mobile communication transmission, and WIFI transmission. Different transmission modes such as WEB, WAP and WWW can achieve the same technical effect in making friends. The same technical effect can be achieved with a Google's Android system, an Apple's iOS system, and other mobile phone operating systems, which are used in mobile communication, hence the same technical effect can be achieved by means of APP, and can be achieved via instant messengers such as WeChat and whatsApp, with a mobile transmission technology.

A recommendation method and a recommendation system applied to a network according to the present disclosure are described in detail hereinafter in the embodiments in conjunction with the drawings.

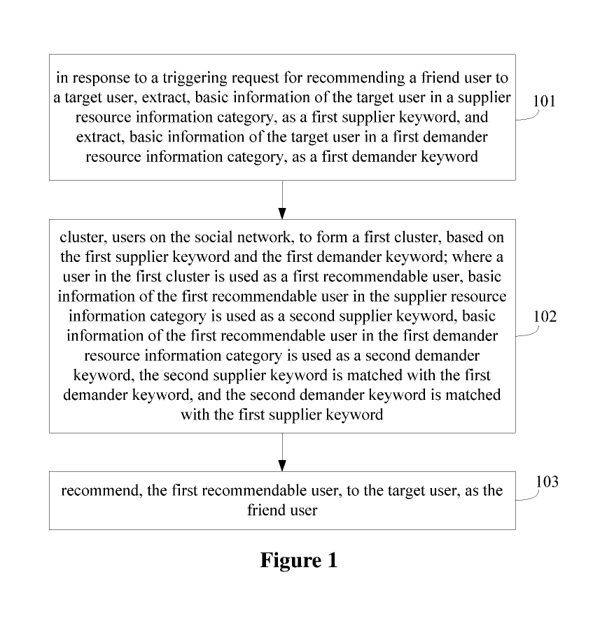

Reference is made to FIG. 1, which illustrates a flow chart of a recommendation method applied to a social network according to an embodiment of the present disclosure. In the embodiment, the method may include the following steps S101 to S103.

In step S101, in response to a triggering request for recommending a friend user to a target user, basic information of the target user in a supplier resource information category is extracted as a first supplier keyword, and basic information of the target user in a first demander resource information category is extracted as a first demander keyword.

In step S102, clustering is performed on users in the social network to form a first cluster, based on the first supplier keyword and the first demander keyword; where a user in the first cluster acts as a first recommendable user, basic information of the first recommendable user in the supplier resource information category is used as a second supplier keyword, basic information of the first recommendable user in the first demander resource information category is used as a second demander keyword, the second supplier keyword is matched with the first demander keyword, and the second demander keyword is matched with the first supplier keyword.

In step S103, the first recommendable user is recommended to the target user as the friend user.

It can be understood that, the embodiment may be implemented by means of interaction between a personal terminal of a user, a server and a database. Specifically, the user may look for a website address to connect to a social network site via a connection between a client and the social network site SNS. Users in the social network site may be differentiated, or connect with each other by using their unique identities IDs; the client may access a clustering module used for matching data, record related information data and send it to a database of the social network site SNS; then, the database of the SNS may receive different pieces of information data which are from clustering modules of different users and perform interactive matching and clustering, to obtain a matching and clustering result revealing whether the users are related; and finally, a server of the SNS may send a matching result to clients of related users, and the related users shown in the matching result may contact with each other in the social network site.

It should be noted that, a clustering information region of each of registered users includes at least one pair of coupling items which are complementary to each other in supply and demand, i.e., a supplier resource information category and a demander resource information category. The coupling items which have coupling and clustering contents are matched and coupled in an intermediate database, precise coupled social relations in which supply and demand are complementary are formed by mapping a coupling result to the different registered users and are fed back to a running page on an interface of a personal terminal of each the registered users. This is an important improvement in the present disclosure. Paired coupling and clustering regions are formed by upgrading ordinary clustering information regions. The coupling mechanism provides a function of benefiting from each other for the registered users, that is, a user may provide an owned resource to another user who demands it, and vice versa. Cooperation based on complementary resources is much more important than cooperation based on similar resources. The establishment of the coupling mechanism realizes a precise social function which is to be achieved by the present disclosure. Clustering based on “enjoying fishing” is taken as an example, surrounding areas of large cities are short of fishing areas now, a coupling item may be set on a registration page of a user: my interest “enjoying fishing” and resource of the others “fishing area”, which constitute a coupled pair, so that a person who dose not enjoy fishing but has a resource of “fishing area” can be coupled and matched with the user quickly. It is assumed that the number of the registered users is ten thousand, then a social group may include 500 users in a case that clustering of a single item with an average ration of 5% is used, and a complementary social group with 25 users who benefit from each other may be precisely located in a case that clustering of coupled items with the same ratio are used. Since the number of users on whom second screening is to be performed is reduced from 500 to 25, workload of the second screening is greatly reduced.

In some implementations of the embodiment, the target user may search for a friend user who has a common characteristic with the target user, in this case, the target user and the friend user may have a same supplier resource, and it is unnecessary to consider whether they have both a same demand resource and a same supply resource. In order to enable the system to recommend such a friend to the target user automatically, the friend user who has a same supplier keyword with the target user may be recommended to the target user when the supplier keyword and the demander keyword inputted by the target user in pair are the same. Specifically, in the embodiment, the method may further include: in response to the first supplier keyword which is the same as the first demander keyword, clustering is performed on the users in the social network to form a second cluster, based on the first supplier keyword, and a second recommendable user is recommended to the target user as the friend user; where a user in the second cluster is used as the second recommendable user, basic information of the second recommendable user in the supplier resource information category is used as a third supplier keyword, and the third supplier keyword is matched with the first supplier keyword. It can be understood that, when the target user needs the system to recommend a user who has a common characteristic with the target user, the target user may input the common characteristic to both the supplier information category and the demander resource information category. In a case that the system realizes that the supplier keyword and the demander keyword of the target are the same, the system determine that a recommendable friend user for the target user has the same supplier keyword with the target user, and performs clustering on users who have the same supplier keywords with the target user to form the second cluster and recommended to the target user.

With the above method for clustering the second cluster, the users are automatically clustered into different groups based on content information of the inputted supplier keyword and the inputted demander keyword. For example, in a case that an information content written in the clustering item of supply and demand is “enjoying fishing”, suppliers who write the same information content are categorized into a group; and in a case that an information content written in the clustering item of supply and demand is “climbing snow mountains”, suppliers who write the same information content are categorized into another group. Certainly, they need to belong to a same clustering item, such as an item of hobby. For performing clustering analysis, at least two users who have clustering items belonging to the same kind are needed, they can not be clustered into a social group in a case that contents written by them are not identical, and they can be clustered into a group into a social group with two members in a case that contents written by them are identical. If more than two social groups of “different kind” are to be formed, then the minimum number of all the users is three, such as three users labeled as A, B and C respectively. If a social group of A and B is to be formed, A and B need to have the clustering item of the same kind. If a social group of B and C is to be formed, B and C need to have the clustering item of the same kind. If a social group of C and A is to be formed, C and A need to have the clustering item of the same kind. If the kinds of the clustering items are different, for example, A and B are clustered based on specialty, B and C are clustered based on interest, and C and A are clustered based on industry, then each of the three users, A, B and C, needs three different kinds of clustering items to establish different kinds of clustering social groups with three different kinds of keywords, which are a social group based on specialty, a social group based on interest and a social group based on industry, respectively. If A, B and C have only one kind of clustering item, such as an clustering item labeled as “specialty”, then three social groups may be formed such as a social group of A and B clustered based on “lawyer”, a social group of B and C clustered based on “accountant” and a social group of C and A clustered based on “engineer”, which are corresponding to a “lawyer” group, an “accountant” group and an “engineer” group respectively and are of the same kind “specialty”.

In some implementations of the embodiment, in consideration that the user may need multiple resources, and it is hard to find the multiple resources demanded from one user, therefore multiple friend uses are needed, to realize matching of the supply and the demand for the user. That is, supplier resources of each of the friend users are matched with only a part of demander resources of the target user, and demander keywords of each of the friend users are matched with supplier keywords of the target user and the other of the friend user respectively. In order to recommend friend users to the target user, clustering may be performed based on mutual matching between the supplier keywords and the demander keywords of the users, and the friend users are recommended to the target user based on a clustering result. Specifically, in the embodiment, the method may further include: in response to the triggering request for recommending the friend user to the target user, basic information of the target user in a second demander resource information category is extracted as a third demander keyword; clustering is performed on the users in the social network to form a third cluster, based on the first supplier keyword, the first demander keyword and the third demander keyword; and a third recommendable user and a fourth recommendable user are recommended to the target user as the friend users; where the third cluster includes the third recommendable user and the fourth recommendable user; basic information of the third recommendable user in the supplier resource information category is used as a fourth supplier keyword, basic information of the third recommendable user in the first demander resource information category is used as a fourth demander keyword, basic information of the third recommendable user in the second demander resource information category is used as a fifth demander keyword, basic information of the fourth recommendable user in the supplier resource information category is used as a fifth supplier keyword, basic information of the fourth recommendable user in the first demander resource information category is used as a sixth demander keyword, basic information of the fourth recommendable user in the second demander resource information category is used as a seventh demander keyword, the first demander keyword and the fourth demander keyword are matched with the fifth supplier keyword, the third demander keyword and the sixth demander keyword are matched with the fourth supplier keyword, and the fifth demander keyword and the seventh demander keyword are matched with the first supplier keyword.

It can be understood that, the above recommendation method for matching the supply and the demand for the three users is very suitable for an entrepreneurial group. It is a basic concept in math that three points define a plane, and there is a similar concept in making friends, that is, three people make up a minimum team. For example, if there are a inventor of a product having the technology but lacking in demand and capital, a dealer having the demand but lacking in technology and capital and an investor having the capital but lacking in technology and demand, then a complementary coupling relation among the three persons is formed based on the product, and there are three coupling relations: a first complementary relation between the inventor “having the technology but lacking in demand” and the dealer “lacking in technology but having the demand”, a second complementary relation between the inventor “having the technology but lacking the capital” and the rich “lacking in technology but having the capital”, and a third complementary relation between the dealer “having the demand but lacking in capital” and the rich “having the capital but lacking in technology”. The three persons may effectively make up an entrepreneurial team that has the technology, the demand and the capital. In general, factors of an enterprise may include five main categories: people, property, goods, entrepreneurs and information, hence five persons each of whom owns one of the five factors respectively can make up an initial entrepreneurial team in principle. Practical researches show that, for achieving good communication, the maximum number of people in a tight team is five. The reason for the above conclusion is that: communication time of a person is limited and can not be used on more than one person, so that bad communication may be caused and work efficiency may be reduced in a case that there are more than five people in the tight team. In a group with five members, each of the members has four pairs of coupling items, so that a complete complementary team with the five members may be formed. In the embodiment, a structure in which there are one supply and two demands is essentially an intersection of two structures in each of which there is one supply and one need. Similarly, a structure in which there are one supply and N demands is essentially an intersection of N structures in each of which there is one supply and one need, and all of supplier keywords are the same and N demander keywords are different. Therefore, a mathematical formula is obtained: for a team with N persons, N−1 pairs of coupling items are needed, so as to meet the requirement of being coupled with each other. The “being coupled with” in the present disclosure refers to coming in a pair or being complementary in the supplies and the demands.

In some implementations of the embodiment, in consideration that the number of the recommended friends obtained by only clustering based on the supplier keywords and the demander keywords may be large and not all the recommended friends are needed by the target user, the target user still needs to perform the second screening on a certain number of recommending results. In order to recommend friend users more precisely and further reduce the number of recommended friends on which the second screening is to be performed by the target user, a fourth cluster may be obtained by clustering based on a property keyword of the target user when the first cluster is obtained by clustering based on the supplier keyword and the demander keyword, and a user in an intersection of the first cluster and the fourth cluster is selected and recommended to the target user as a friend user, so that the recommended friend and the target user are not only complementary in the supply and demand resources but also have the same property, thereby enabling the friend recommendation to be precise and further reducing the number of recommended friends on which the second screening is to be performed by the target user. Specifically, in the embodiment, the method may further include: in response to the triggering request for recommending the friend user to the target user, extracting basic information of the target user in a property resource information category as a first property keyword; performing clustering on the users in the social network to form a fourth cluster, based on the first property keyword; where a user in the fourth cluster acts as a fourth recommendable user, basic information of the fourth recommendable user in the property resource information category is used as a second property keyword, and the second property keyword is matched with the first property keyword; and recommending a fifth recommendable user to the target user as a friend user, where a user who is included in both the first cluster and the fourth cluster is used as the fifth recommendable user, and the fifth recommendable user is a first recommendable user and a fourth recommendable user.

In the embodiment, the clustering refers to matching of specific keywords of the users. For example, the supplier keyword of the target user is matched with the demander keyword of the friend user. As another example, the supplier keywords of the target user and the friend user are matched. It can be understood that, matching of two keywords may refer to matching of a supplier keyword and a demander keyword, or refer to matching of two supplier keywords. For example, it may refer to the fact that the two matched keywords are exactly the same in content and form of expression. As another example, it may refer to the fact that the two matched keywords are only exactly the same in content. As another example, it may refer to the fact that the two matched keywords are similar in content. Specifically, a requirement on the clustering in the embodiment may be set from being loose to being “exactly the same”, which is adjusted by a clustering determining rule set by the SNS. For example, in a case that words are required to be “exactly the same”, “red colour” and “red” can not be clustered since the numbers of the words are not the same. In a case that the requirement is looser, the “red colour” and the “red” can be clustered. a vertical relation of “being generic or subordinate” and a horizontal relation of “difference and correspondence”, among keywords or terms, are involved herein, such as clustering of “dark red”, “light red”, “peach” and “pink”. Rigorousness and looseness of different languages are also involved, for example, clustering rules of “ [symbol] ”, “hot working”, “hot-working” and “Thermal processing” are difficult to master, whereas it is easy in a case of clustering words in the same language.

In some implementations of the embodiment, in consideration that a user may have multiple intensions of making friends or have multiple different social roles, and that the user may have different supplier resources and demander resources for different roles, the user may want to search for different friend users for different roles. In order to recommend friend users based on requirements of the target user in different roles, correspondences between the social roles and information categories may be established in advance. When friend users need to be recommended, different social roles may be inputted by the target user, and pieces of basic information in the corresponding information categories are selected as supplier keywords and demander keywords, to perform clustering based on the different supplier keywords and the different demander keywords for different roles, thereby recommending the different friend users to the target user. Specifically, in the embodiment, the method may further include: in response to an operation of inputting a target social role performed by the target user, the supplier resource information category and the first demander resource information category are determined from multiple optional information categories, based on the target social role; where correspondence is established among the target social role, the supplier resource information category and the first demander resource information category, in advance. It can be understood that, the target social role may be inputted by the user by means of manually inputting in a box for inputting the social role, or, the target social role may be selected by the user from multiple optional social roles which are provided by the system to the user.

In the implementations in which the supplier keywords and the demander keywords are obtained based on the social role inputted by the user, a social role may be selected by the user after he or she registers or logs in with an ID, and the multiple social roles may be set by the social network site SNS. It can be understood that, a person plays different roles on different occasions: being a son when facing the father, being a father when facing the son and being a husband when facing the wife. On different occasions, requirements on making friends are also different: looking for a friend based on a hobby is different from looking for a friend based on a specialty, and looking for a spouse is different from looking for a business partner. Hence, introducing of the social roles in an ID module enables corresponding clustering modules of different roles to more precisely locate the different social roles in real life, and enable the clustering mechanism in the present disclosure to be more precise.

In some implementations of the embodiment, the following situation is taken into consideration: in order to improve possibility of being recommended, some users may deliberately input supplier keywords and demander keywords which do not match conditions of them when they see supplier keywords and demander keywords of other users which are used for clustering, to enable the false keywords of them to be match with the supplier keywords and the demander keywords of other users, so that the users may be recommended but effects of making friends of the other users may be impaired. To avoid such a situation, the pieces of basic information of the target user in information categories which can be used for clustering, may not be visible to other users, and the information categories which can be used for clustering may include the supplier resource information category and the first demander resource information category. For example, supplier keywords and demander keywords may be implemented in a form of hidden label, so that the supplier keyword and the demander keywords of the target user are not visible to other users.

In some implementations of the embodiment, in consideration that the clustering is used by the system to automatically recommend the friend user to the target user, the pieces of basic information of the target user in information categories which can be used for clustering, may included in registration information of the target user, for purpose of facilitating the system to automatically recommend the friend user to the target user. In this case, the pieces of basic information which can be used for clustering needs to be inputted in the system when the target user registers, so that the system may recommend the friend user obtained by clustering based on registration information to the target user at any time, and the target user does not need to input the supplier keywords and the demander keywords used for clustering every time recommending is needed.

It can be understood that, in a case that supplier keywords and demander keywords of a user which are used for clustering are not visible to other users, clustering content inputted by the user may be reflected on a registration page, and the other users can not see the clustering content, so that a situation, in which incorrect matching is caused due to the fact that some users change their own clustering content to approach another user after they see supplier keywords and demander keywords of the user, may be avoided. A user can input requirements on making friend without being influenced by the surrounding, based on clustering mechanism of a clustering module of the SNS, and matching of users are performed in a black-box-like manner, which eliminates intermediation and is precise. In addition, after several times of changing content information in a registration clustering module, a netizen can precisely find another netizen that he or she wants to contact. Black box mapping with the clustering module on the registration page is the best mechanism of the present disclosure.

In some implementations of the embodiment, the supplier keywords or the demander keywords of the user may include numerical values. It can be understood that, in a case that the clustering is performed based on the keywords including the numerical values, mapping of the keywords including the numerical values may refer to that an error between the numerical values of the keywords is in a preset error range, so that it can be avoided that the recommendable friend can not be obtained by clustering. Specifically, in the embodiment, in a case that the first supplier keyword and the second demander keyword each include a numerical value, it is indicated that an error between the numerical value of the first supplier keyword and the numerical value of the second supplier keyword is in a preset reasonable error range if the first supplier keyword is matched with the second demander keyword. In some specific application scenarios, the clustering is performed based on the keywords which are numerical values, when the target user has requirements in form of numerical values. In case of making friends with the opposite sex, in order to find users who are about 25 years old, the clustering may be performed based on an age plus or minus 2 years which is set by the website; in a case of directed borrowing, such as the P2P peer-to-peer, the clustering may be performed based on plus or minus 10% which is set by the website when one side wants to borrow 300 thousand, and clustering of two netizens is successful if another side has 320 thousand and other conditions are mapped. The key is setting of the clustering threshold, such as the above ±10% and ±2 years. Of course a unidirectional threshold may be set. The most strict threshold is zero, that is, the numbers are “exactly the same”.

In some implementations of the embodiment, the supplier keyword or the demander keywords of the user may include numerical ranges. It can be understood that, in a case that the clustering is performed based on the keywords including the numerical ranges, mapping of the keywords including the numerical ranges may refer to that a coincidence degree between the numerical ranges of the keywords reaches a preset threshold, so that it can be avoided that the recommendable friend can not be obtained by clustering. Specifically, in the embodiment, in a case that the first supplier keyword and the second demander keyword each include a numerical range, it is indicated that a coincidence degree between the numerical range of the first supplier keyword and the numerical range of the second demander keyword is greater than or equal to a preset coincidence degree threshold if the first supplier keyword is matched with the second demander keyword. In some specific application scenarios, the clustering is performed based on the keywords including the numerical ranges, the system operates in a threshold determining mechanism in which it is determined whether it is interactively clustered based on a coincidence percentage is fed back on the operation page on an interface of the personal terminal. For example, if a numerical range of a registered user A is from 100 to 200, and a numerical range of another registered user B is from 80 to 180, then a coincidence interval between them is from 100 to 180, which has a coincidence degree of 80% equal to the coincidence degree threshold. If the numerical range of B is from 105 to 180, then the coincidence degree is 75% and the clustering is not to be performed. If the numerical range of B is from 105 to 200, then the coincidence degree is 85% and the clustering is to be performed. The coincidence degree may be set based on the tow endpoints of a numerical range. For example, a numerical range of a registered user A is from 100 to 200, if the threshold value of the endpoints is set as ±5%, both of the numerical rang from 95 to 100 and the numerical range from 105 to 190 of the registered user B reach the preset coincidence degree.

In some implementations of the embodiment, after the friend user is recommended to the target user, the target user and the friend user may need to perform collaborative editing on a same file. The target user needs to know the editing of the friend user and the friend user needs to know the editing of the target user. In order to facilitate the target user and the friend user to perform the collaborative editing on the same file, a communication connection between them for synchronously editing the same file may be established, and an editing operation of each of them is fed back to the other via the communication connection. Specifically, in the embodiment, the method may further include: in response to a request triggered by the target user for editing an object file in synchronization with the friend user, a communication connection for synchronously editing the object file, between the target user and the friend user, is established; and in response to an editing operation of the target user and/or the friend user on the object file, the object file on which the editing operation is performed is presented to the target user and the friend user simultaneously, via the communication connection. The establishing of the communication connection and the presenting of the editing operation may be implemented by a program for collaboratively editing at different times and in different places which is included in the system. After it is accepted by registered users in a social relation, an interactive collaborative editing of a document may be initiated, so that remote communication can be greatly facilitated by the remote asynchronous collaborative editing, which is beneficial to generate creative idea works such as brainstorming, architecture design drawing, mechanical design drawing, work flow chart and artistic creation. It can be understood that, in some specific application scenarios, a complementary relation is formed between resources of two sides, such as resources of a plaintiff or a defendant and an attorney, resources of an inventor and a patent attorney, resources of an owner and a designer, and resources of a renter and a tenant. In practice, the resources in the complementary relation need to be used in cooperative work and cooperative creation, and achievements of the cooperation are reflected in a written document. With software for collaboratively editing in the SNS, travel expense and time can be effectively saved. In addition, the system may perform timing for the document editing performed by the registered users, to compute time-based payments, which is specifically suitable for intellectual service industries such as accounting profession, lawyer profession and engineer profession. Specifically, a user instruction can be started based on a collaborative editing program, the SNS may automatically compute cumulative time spent by the user on the collaborative editing program, compute time-based payments of the netizens during the time for collaboratively editing, so that a circulation of making friends, cooperation and payment is formed, which is a direction of continual improvement of the present disclosure.

It should be noted that, in some implementations of the embodiment, the supplier keyword and the demander keyword of the target user may be used to search for information which interest the target user and recommend the information to the target user, in addition to being used for recommending the friend user to the target user by clustering. Specifically, in the embodiment, the method may further include: information matched with the first supplier keyword and/or the first demander keyword is found as a search result, with a search engine or a search database, based on the first supplier keyword and the first demander keyword, and the search result is recommended to the target user. It can be understood that, in consideration of a job or an interest of a user, online information such as a patent database or a database of other industry usually need to be searched, hence, by combining content of clustering data into a search keyword, automatically searching it and periodically recommending the latest search result, time is effectively saved and the latest industry information can be known in real time. Similarly, the website system may establish an automatic advertisement recommending module, which may recommend matched advertisements to a terminal of a user based on the supplier keyword and the demander keyword, so that a closed-loop circulation of profit pattern is formed by the system.

Specifically, in the implementations in which the search result is recommended to the target user by searching for the supplier keyword and the demander keyword, web pages and a specific database are connected to a mediation database and a mediation server with a search engine group, inputted data of supplier keywords and demander keywords of registered members constitutes searching preconditions of the search engine group. The search engine group has a built-in program for automatically periodically managing and allocating time, which is periodically used by effectively registered users based on the number of the effectively registered users. The search result of the search engine group is automatically triggered by the server on schedule, so as to store it in the server, and is mapped to different registered users, and the search result is fed back and recommended to a running page on an interface of a personal terminal.

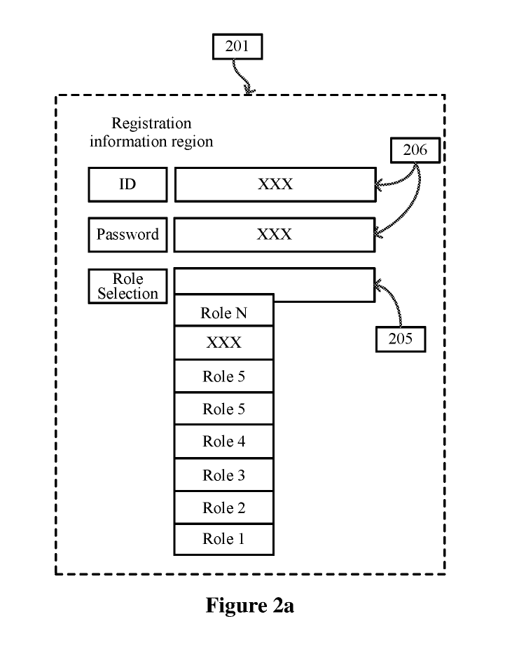

In order to enable those skilled in the art to understand the implementations of the embodiment more intuitively, an example of a possible user operation interface is described herein after, and reference is made to FIG. 2.

FIG. 2a illustrates an example of a user operation interface of a registration information region 201, and FIG. 2b illustrates an example of a user operation interface of a clustering information region 202. It can be understood that, the registration information region 201 and the clustering information region 202 may be presented on a same wed page or on a same display interface of a client, or, the registration information regions 201 and the clustering information region 202 may be respectively presented on two different web pages or two different display interfaces of a client. An interface on a terminal may include multiple kinds of pages such as a login page, a registration page and an operation page. An interface may be displayed in sub-regions, a page may be a whole interface or be constituted of several sequentially connected interfaces. The regions in which a registered user inputs data are set as the registration information region 201 and the clustering information region 202 are set respectively, clustering is performed by using the clustering information region 202, by which the method for organizing a social group on the Internet, which can search for clustering friends from a maximum range of netizens and greatly reduce a cost of the second screening, is provided.

In the registration information region 201, input boxes 206 are used to input information of user identity such as a user ID and a user password; and an input box 205 is used to input a social role of the user. Multiple optional social roles are provided to the user by means of a pull-down menu, to facilitate the user to select a target social role, and the corresponding target social role is displayed in the input box 205.

In the clustering information region 202, input boxes 203 are used to input basic information in a supplier resource information category and basic information in demander resource information categories, that is, a supplier keyword and demander keywords are inputted by the user with the input boxes 203, and an input box 207 is used to input basic information in a property resource information category; buttons 204 are used by the user to select keywords based which clustering is performed. In a case that the button 204 “supplier” is selected by the user, the clustering may be performed only based on the supplier keyword; in a case that the button 204 “demander 1” is selected by the user, the clustering may be performed based on both the supplier keyword and the demander 1 keyword; and in a case that the button 204 “supplier 2” is selected by the user, the clustering may be performed based on the supplier keyword, the demander 1 keyword and the demander 2 keyword. With the buttons 204, item controls in the clustering module may be large and comprehensive, and the user may select one or several clustering item controls based on his or her needs for making friends to quickly achieve the object of making friends. The social network site may set the control as a radio control or a check box control, and set multiple clustering logic may, such as “or”, “no”.

For the related information of the user identity, in some implementations, the social network may include an interface for connecting to a national identity card database, the registration page on the personal terminal includes an identity inputting index item, and an operation page for performing interactive verification on identity information inputted on the person terminal and feeding back a verification result to an interface of the person terminal of a registered user, which greatly improves reliability of the virtual social network, has an effect similar to that of offline face-to-face communication, and improves security of business transaction.

For the related information of the user identity, in some implementations, the client connected to the social network may include a biological information collecting device, and biological information is sent to the social network for storing or verifying. The biological information may be a recognition ID or complement verification for the recognition ID. The biological information usually includes a fingerprint, a palmprint, grain on a retina, face recognition and so on, where the fingerprint is the easiest to use. PCs, mobile phones and other devices may include fingerprint collecting devices now, and a national database of second-generation identity cards includes pieces of fingerprint information. A person can be targeted based on biological validation, so that a 100% of identity and credit authentication is achieved. The collected palmprint or the collected grain on the retina may be provided to a public security organ for verifying when there is a dispute in making friends, which can improve the anti-spoofing ability of the SNS. In addition, the biological information may be used as a unique user ID. The biological information ID is extremely secure when used for logging in or registering, so that an era of making friends with biological information ID which is advanced and reliable has come. In a case that the grain on the retina which is non-contacting is used for registering and logging in, or used for online validation, a real-time online friend-making method which integrates online and offline is basically achieved, and in theory, an integrated real-time online friend-making is achieved, which has special significance for a target user making a business friend having a transaction relationship between the target user.

For the related information of the user identity, in some implementations, the recognition ID in a registration information ID module may be an ID in offline real life, such as mobile phone number, identity card or bank card. The SNS database include the interface for connecting to the national identity card database, so that the offline and the online can be integrated, which is beneficial to establishing of credit verification of the SNS. The real identity of a netizen can be verified by connecting to the national identity card database. The credit state of a netizen can be verified by connecting to a national credit reporting agency. Trust between mapped netizens is enhanced, which facilitates to conduct offline activities and business activities. Using a mobile phone number as an ID may establish connections to a phone book and a phone book database. By using a link of making friends with the mobile phone number, another method for verifying credit is provided. Cross verification improves the reliability of making friends. In addition, the website may be transformed into an instant messaging website, which greatly increases the speed of making friends on the website and the speed of verification.

In addition, the above registration page may include a front registration information ID module. When information ID is registered, data of the ID module is sent to the SNS and a clustering module is sent back for continuing recording data information. Data on the registration page is divided into a data package of the ID module and a data package of the clustering module and are sent to the server of the SNS in two times for processing. This manner is suitable for APP and a B/S structure, that is, data of the ID module and data of clustering module are presented on the registration page for two times. Main software and most of the system is placed on the server of the SNS, which may greatly reduce difficulty in developing software of a personal client.

With the technical solutions in the embodiment, clustering is performed on users in a social network, based on a supplier keyword inputted in a supplier resource information category by a user and demander keywords inputted in demander resource information categories by the user, and a friend user is recommended to the user based on the clustering result. Then, the friend users, who have supplier keywords matched with the demander keyword of the target user and demander keywords matched with the supplier keyword of the target user, can be recommended to the target user by clustering, and the target user does not need to know user identity information of them. Hence, even if the friend users are not familiar to the target user, they can be precisely recommended to the target user by the system in one attempt, thereby greatly reducing the search results on which the second screening is to be performed by the user and saving time and energy consumed in performing the second screening on the search results for the user.

In accordance with the method embodiment, a recommendation system applied to a social network is also provided according to the present disclosure.

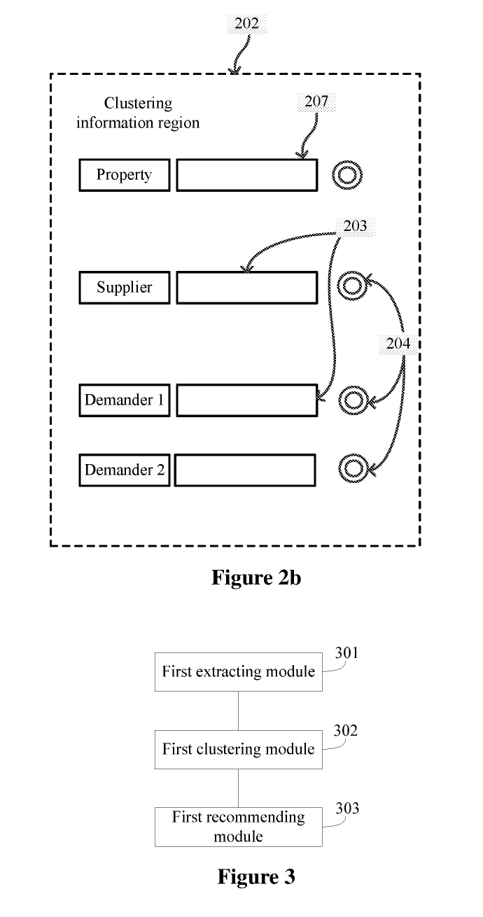

Reference is made to FIG. 3, which illustrate a structural diagram of the recommending system applied to the social network according to an embodiment of the present disclosure. In the embodiment, the system may include:

a first extracting module 301, configured to, in response to a triggering request for recommending a friend user to a target user, extract basic information of the target user in a supplier resource information category as a first supplier keyword, and extract basic information of the target user in a first demander resource information category as a first demander keyword;

a first clustering module 302, configured to perform clustering on users in the social network to form a first cluster, based on the first supplier keyword and the first demander keyword; where a user in the first cluster acts as a first recommendable user, basic information of the first recommendable user in the supplier resource information category is used as a second supplier keyword, basic information of the first recommendable user in the first demander resource information category is used as a second demander keyword, the second supplier keyword is matched with the first demander keyword, and the second demander keyword is matched with the first supplier keyword; and

a first recommending module 303, configured to recommend the first recommendable user to the target user as the friend user.

In some implementations of the embodiment, the system may further include:

a second clustering module, configured to, in response to the first supplier keyword which is the same as the first demander keyword, perform clustering on the users in the social network to form a second cluster, based on the first supplier keyword; where a user in the second cluster acts as a second recommendable user, basic information of the second recommendable user in the supplier resource information category as a third supplier keyword, and the third supplier keyword is matched with the first supplier keyword; and

a second recommending module, configured to recommend the second recommendable user to the target user as the friend user.

In some implementations of the embodiment, the system may further include:

a second extracting module, configured to, in response to the triggering request for recommending the friend user to the target user, extract basic information of the target user in a second demander resource information category as a third demander keyword;

a third clustering module, configured to perform clustering on the users in the social network to form a third cluster, based on the first supplier keyword, the first demander keyword and the third demander keyword; where the third cluster includes a third recommendable user and a fourth recommendable user; basic information of the third recommendable user in the supplier resource information category is used as a fourth supplier keyword, basic information of the third recommendable user in the first demander resource information category is used as a fourth demander keyword, basic information of the third recommendable user in the second demander resource information category is used as a fifth demander keyword, basic information of the fourth recommendable user in the supplier resource information category is used as a fifth supplier keyword, basic information of the fourth recommendable user in the first demander resource information category is used as a sixth demander keyword, basic information of the fourth recommendable user in the second demander resource information category is used as a seventh demander keyword, the first demander keyword and the fourth demander keyword are matched with the fifth supplier keyword, the third demander keyword and the sixth demander keyword are matched with the fourth supplier keyword, and the fifth demander keyword and the seventh demander keyword are matched with the first supplier keyword; and

a third recommending module, configured to recommend the third recommendable user and the fourth recommendable user to the target user as the friend users.

In some implementations of the embodiment, the system may further include:

a determining module, configured to, in response to an operation of inputting a target social role performed by the target user, determine the supplier resource information category and the first demander resource information category from multiple optional information categories, based on the target social role; where correspondence is established between the target social role, the supplier resource information category and the first demander resource information category, in advance.

In some implementations of the embodiment, the pieces of basic information of the target user in information categories which can be used for clustering, are not visible to other users, and the information categories which can be used for clustering may include the supplier resource information category and the first demander resource information category.

In some implementations of the embodiment, the pieces of basic information of the target user in information categories which can be used for clustering, may be included in registration information of the target user.

In some implementations of the embodiment, in a case that the first supplier keyword and the second demander keyword each include a numerical value, it is indicated that an error between the numerical value of the first supplier keyword and the numerical value of the second demander keyword is in a preset reasonable error range if the first supplier keyword is matched with the second demander keyword.

In some implementations of the embodiment, in a case that the first supplier keyword and the second demander keyword each include a numerical range, it is indicated that a coincidence degree between the numerical rang of the first supplier keyword and the numerical range of the second demander keyword is greater than or equal to a preset coincidence degree threshold if the first supplier keyword is matched with the second demander keyword.

In some implementations of the embodiment, the system may further include:

an establishing module, configured to, in response to a request triggered by the target user for editing an object file in synchronization with the friend user, establish a communication connection for synchronously editing the object file between the target user and the friend user; and

a presenting module, configured to, in response to an editing operation of the target user and/or the friend user on the object file, present the object file on which the editing operation is performed to the target user and the friend user simultaneously via the communication connection.

In some implementations of the embodiment, the system may further include:

a fourth recommending module, configured to search for information matched with the first supplier keyword and/or the first demander keyword as a search result, with a search engine or a search database, based on the first supplier keyword and the first demander keyword, and recommend the search result to the target user.

In some implementations of the embodiment, the system may further include:

a third extracting module, configured to, in response to the triggering request for recommending the friend user to the target user, extract basic information of the target user in a property resource information category as a first property keyword;

a fourth clustering module, configured to perform clustering on, the users in the social network to form a fourth cluster, based on the first property keyword; where a user in the fourth cluster acts as a fourth recommendable user, basic information of the fourth recommendable user in the property resource information category is used as a second property keyword, and the second property keyword is matched with the first property keyword; and

a fifth recommending module, configured to recommend a fifth recommendable user to the target user as the friend user, where a user who is included in both the first cluster and the fourth cluster acts as the fifth recommendable user, and the fifth recommendable user is a first recommendable user and a fourth recommendable user.

With the technical solutions in the embodiments, clustering is performed on users in a social network, based on supplier keywords inputted in a supplier resource information category by a user and demander keywords inputted in demander resource information categories by the user, and a friend user is recommended to the user based on a clustering result. Then, the friend users, who have supplier keywords matched with the demander keywords of the target user and demander keywords matched with the supplier keyword of the target user, can be recommended to the target user by clustering, and the target user does not need to know user identity information of them. Hence, even if the friend users are not familiar to the target user, they can be precisely recommended to the target user by the system in one attempt, thereby greatly reducing the search results on which the second screening is to be performed by the user and saving time and energy consumed in performing the second screening on the search results for the user.

It should be noted that, relational terms in the present disclosure such as the first or the second are only used to differentiate one entity or operation from another entity or operation rather than require or indicate the actual existence of the relation or sequence among the entities or operations. Terms such as “include”, “comprise” or any other variants are meant to cover non-exclusive enclosure, so that the process, method, item or device comprising a series of elements not only include the elements but also include other elements which are not specifically listed or the inherent elements of the process, method, item or device. With no other limitations, the element restricted by the phrase “include a . . . ” does not exclude the existence of other same elements in the process, method, item or device including the element.

Since the system embodiment is basically corresponding to the method embodiment, please refer to the descriptions of the method embodiment for the related contents. The system embodiment described above is only illustrative. The units described as separate components may be or not be separated physically. The components shown as units may either be or not be physical units, that is, the units may be located at one place or may be distributed onto multiple network units. All of or part of the units may be selected based on actual needs to implement the solutions according to the embodiment. It can be understood and implemented by those ordinarily skilled in the art without any creative efforts.

The above descriptions are only embodiments of the present disclosure. It should be noted that various changes and modifications can be made by those ordinarily skilled in the art without departing from the principle of the present disclosure, which fall within the protection scope of the present disclosure.

1. A recommendation method, applied to a social network, comprising:
in response to a triggering request for recommending a friend user to a target user, extracting basic information of the target user in a supplier resource information category as a first supplier keyword, and extracting basic information of the target user in a first demander resource information category as a first demander keyword;
performing clustering on users in the social network to form a first cluster, based on the first supplier keyword and the first demander keyword; wherein a user in the first cluster acts as a first recommendable user, basic information of the first recommendable user in the supplier resource information category is used as a second supplier keyword, basic information of the first recommendable user in the first demander resource information category is used as a second demander keyword, the second supplier keyword is matched with the first demander keyword, and the second demander keyword is matched with the first supplier keyword; and
recommending the first recommendable user to the target user as the friend user.

2. The method according to claim 1, further comprising:
in response to the first supplier keyword which is the same as the first demander keyword, performing clustering the users in the social network to form a second cluster, based on the first supplier keyword; wherein a user in the second cluster acts as a second recommendable user, basic information of the second recommendable user in the supplier resource information category is used as a third supplier keyword, and the third supplier keyword is matched with the first supplier keyword; and
recommending the second recommendable user, to the target user, as the friend user.

3. The method according to claim 1, further comprising:
in response to the triggering request for recommending the friend user to the target user, extracting basic information of the target user in a second demander resource information category as a third demander keyword;
performing clustering on the users in the social network to form a third cluster, based on the first supplier keyword, the first demander keyword and the third demander keyword;
wherein the third cluster comprises a third recommendable user and a fourth recommendable user; basic information of the third recommendable user in the supplier resource information category is used as a fourth supplier keyword, basic information of the third recommendable user in the first demander resource information category is used as a fourth demander keyword, basic information of the third recommendable user in the second demander resource information category is used as a fifth demander keyword, basic information of the fourth recommendable user in the supplier resource information category is used as a fifth supplier keyword, basic information of the fourth recommendable user in the first demander resource information category is used as a sixth demander keyword, basic information of the fourth recommendable user in the second demander resource information category is used as a seventh demander keyword, the first demander keyword and the fourth demander keyword are matched with the fifth supplier keyword, the third demander keyword and the sixth demander keyword are matched with the fourth supplier keyword, and the fifth demander keyword and the seventh demander keyword are matched with the first supplier keyword; and
recommending the third recommendable user and the fourth recommendable user to the target user as the friend users.

4. The method according to claim 1, further comprising:
in response to an operation of inputting a target social role performed by the target user, determining the supplier resource information category and the first demander resource information category, from a plurality of optional information categories, based on the target social role; wherein correspondence is established among the target social role, the supplier resource information category, and the first demander resource information category, in advance.

5. The method according to claim 1, wherein the pieces of basic information of the target user in information categories which can be used for clustering, are not visible to other users, and the information categories which can be used for clustering comprise the supplier resource information category and the first demander resource information category.

6. The method according to claim 1, wherein the pieces of basic information of the target user in information categories which can be used for clustering, are comprised in registration information of the target user.

7. The method according to claim 1, wherein in a case that the first supplier keyword and the second demander keyword each comprise a numerical value, it is indicated that an error between the numerical value of the first supplier keyword and the numerical value of the second demander keyword is in a preset reasonable error range if the first supplier keyword is matched with the second demander keyword.

8. The method according to claim 1, wherein in a case that the first supplier keyword and the second demander keyword each comprise a numerical range, it is indicated that a coincidence degree between the numerical range of the first supplier keyword and the numerical range of the second demander keyword is greater than or equal to a preset coincidence degree threshold if the first supplier keyword is matched with the second demander keyword.

9. The method according to claim 1, further comprising:
in response to a request triggered by the target user for editing an object file in synchronization with the friend user, establishing a communication connection for synchronously editing the object file between the target user and the friend user; and
in response to an editing operation of the target user and/or the friend user on the object file, presenting the object file on which the editing operation is performed, to the target user and the friend user simultaneously, via the communication connection.

10. The method according to claim 1, further comprising:
searching for information matched with the first supplier keyword and/or the first demander keyword as a search result, with a search engine or a search database, based on the first supplier keyword and the first demander keyword, and recommending the search result to the target user.

11. The method according to claim 1, further comprising:
in response to the triggering request for recommending the friend user to the target user, extracting basic information of the target user in a property resource information category as a first property keyword;
performing clustering on the users in the social network to form a fourth cluster, based on the first property keyword; wherein a user in the fourth cluster acts as a fourth recommendable user, basic information of the fourth recommendable user in the property resource information category is used as a second property keyword, and the second property keyword is matched with the first property keyword; and
recommending a fifth recommendable user to the target user as the friend user, wherein a user who is comprised in both the first cluster and the fourth cluster acts as the fifth recommendable user, and the fifth recommendable user is a first recommendable user and a fourth recommendable user.

12. A recommendation system, applied to a social network, comprising:
a first extracting module, configured to, in response to a triggering request for recommending a friend user to a target user, extract basic information of the target user in a supplier resource information category as a first supplier keyword, and extract basic information of the target user in a first demander resource information category as a first demander keyword;
a first clustering module, configured to perform clustering on users in the social network to form a first cluster, based on the first supplier keyword and the first demander keyword; wherein a user in the first cluster acts as a first recommendable user, basic information of the first recommendable user in the supplier resource information category is used as a second supplier keyword, basic information of the first recommendable user in the first demander resource information category is used as a second demander keyword, the second supplier keyword is matched with the first demander keyword, and the second demander keyword is matched with the first supplier keyword; and
a first recommending module, configured to recommend the first recommendable user to the target user as the friend user.

13. The system according to claim 12, further comprising:
a second clustering module, configured to, in response to the first supplier keyword which is the same as the first demander keyword, perform clustering on the users in the social network to form a second cluster, based on the first supplier keyword; wherein a user in the second cluster acts as a second recommendable user, basic information of the second recommendable user in the supplier resource information category as a third supplier keyword, and the third supplier keyword is matched with the first supplier keyword; and
a second recommending module, configured to recommend the second recommendable user to the target user as the friend user.

14. The system according to claim 12, further comprising:
a second extracting module, configured to, in response to the triggering request for recommending the friend user to the target user, extract basic information of the target user in a second demander resource information category as a third demander keyword;
a third clustering module, configured to perform clustering on the users in the social network to form a third cluster, based on the first supplier keyword, the first demander keyword and the third demander keyword; wherein the third cluster comprises a third recommendable user and a fourth recommendable user; basic information of the third recommendable user in the supplier resource information category is used as a fourth supplier keyword, basic information of the third recommendable user in the first demander resource information category is used as a fourth demander keyword, basic information of the third recommendable user in the second demander resource information category is used as a fifth demander keyword, basic information of the fourth recommendable user in the supplier resource information category is used as a fifth supplier keyword, basic information of the fourth recommendable user in the first demander resource information category is used as a sixth demander keyword, basic information of the fourth recommendable user in the second demander resource information category is used as a seventh demander keyword, the first demander keyword and the fourth demander keyword are matched with the fifth supplier keyword, the third demander keyword and the sixth demander keyword are matched with the fourth supplier keyword, and the fifth demander keyword and the seventh demander keyword are matched with the first supplier keyword; and
a third recommending module, configured to recommend the third recommendable user and the fourth recommendable user to the target user as the friend users.

15. The system according to claim 12, further comprising:
a determining module, configured to, in response to an operation of inputting a target social role performed by the target user, determine the supplier resource information category and the first demander resource information category from a plurality of optional information categories, based on the target social role; wherein correspondence is established among the target social role, the supplier resource information category and the first demander resource information category, in advance.

16. The system according to claim 12, wherein the pieces of basic information of the target user in information categories which can be used for clustering, are not visible to other users, and the information categories which can be used for clustering comprise the supplier resource information category and the first demander resource information category.

17. The system according to claim 12, wherein the pieces of basic information of the target user in information categories which can be used for clustering, are comprised registration information of the target user.

18. The system according to claim 12, wherein in a case that the first supplier keyword and the second demander keyword each comprise a numerical value, it is indicated that an error between the numerical value of the first supplier keyword and the numerical value of the second demander keyword is in a preset reasonable error range if the first supplier keyword is matched with the second demander keyword.

19. The system according to claim 12, wherein in a case that the first supplier keyword and the second demander keyword each comprise a numerical range, it is indicated that a coincidence degree between the numerical range of the first supplier keyword and the numerical range of the second demander keyword is greater than or equal to a preset coincidence degree threshold if the first supplier keyword is matched with the second demander keyword.

20. The system according to claim 12, further comprising:
an establishing module, configured to, in response to a request triggered by the target user for editing an object file in synchronization with the friend user, establish a communication connection for synchronously editing the object file between the target user and the friend user; and
a presenting module, configured to, in response to an editing operation of the target user and/or the friend user on the object file, present the object file on which the editing operation is performed to the target user and the friend user simultaneously via the communication connection.

21. The system according to claim 12, further comprising:
a fourth recommending module, configured to search for information matched with the first supplier keyword and/or the first demander keyword as a search result, with a search engine or a search database, based on the first supplier keyword and the first demander keyword, and recommend the search result to the target user.

22. The system according to claim 12, further comprising:
a third extracting module, configured to, in response to the triggering request for recommending the friend user to the target user, extract basic information of the target user in a property resource information category as a first property keyword;
a fourth clustering module, configured to perform clustering on the users in the social network to form a fourth cluster, based on the first property keyword; wherein a user in the fourth cluster acts as a fourth recommendable user, basic information of the fourth recommendable user in the property resource information category is used as a second property keyword, and the second property keyword is matched with the first property keyword; and
a fifth recommending module, configured to recommend a fifth recommendable user to the target user as the friend user, wherein a user who is comprised in both the first cluster and the fourth cluster acts as the fifth recommendable user, and the fifth recommendable user is a first recommendable user and a fourth recommendable user.
